(19) United States
(12) Patent Application Publication
(10) Pub. No.: US 2026/0251466 A1
(43) Pub. Date: Aug. 27, 2026

(54) METHOD AND SYSTEM FOR AUTONOMOUS VEHICLE DROP OFF DESTINATION SUITABILITY ASSESSMENT

(71) Applicant: INTERNATIONAL BUSINESS MACHINES CORPORATION, Armonk, NY (US)

(72) Inventors: Sarbajit Kumar Rakshit, Kolkata (IN); Manikandan Padmanaban, Chennai (IN); Jagabondhu Hazra, Bangalore (IN)

(21) Appl. No.: 19/060,140

(22) Filed: Feb. 21, 2025

(51) Int. Cl. G01C 21/34; B60W 60/00; G01C 21/36; G06Q 50/26; G06Q 50/40

(52) U.S. Cl. CPC G01C 21/3461; B60W 60/0016; G01C 21/3484; G01C 21/3691; G06Q 50/265; G06Q 50/40

(57) ABSTRACT

Systems, methods, and computer program products for determining a destination for dropping-off one or more passengers of an autonomous vehicle are described. An initial drop-off destination and data related to the initial drop-off destination and to one or more passenger profiles, are received. A suitability score, corresponding to a riskiness of dropping-off the one or more passengers at the initial drop-off destination, is determined for the initial drop-off destination based on the data. The suitability score is compared to a pre-determined suitability threshold. When the comparison indicates that the initial drop-off destination is unsuitable, an area bounding the initial drop-off destination, where unsuitable conditions exist is determined, based on the event data. At least one alternate drop-off destination is determined based on the area bounding the initial drop-off destination. A selection of one of the at least one alternate drop-off destinations for dropping-off the one or more passengers is received.

### BACKGROUND

Embodiments of the present disclosure relate to systems and methods for dropping off passengers at destinations in an autonomous vehicle, and more specifically, to methods for dropping off passengers in safe and suitable destinations in autonomous vehicles.

While riding in an autonomous vehicle, a passenger may choose a drop-off destination. In some instances, the drop-off destination provided by the passenger may be unsuitable due to accidents, natural disasters, and/or the like occurring there. Thus, there exists a need in the art for a system and method for assessing a drop-off destination and providing a passenger with suitable alternate drop-off destinations if needed.

### BRIEF SUMMARY

According to embodiments of the present disclosure, systems, methods of, and computer program products for determining a destination for dropping-off one or more passengers of an autonomous vehicle are disclosed. In various embodiments, a method for determining a destination for dropping-off one or more passengers of an autonomous vehicle is provided. An initial drop-off destination is received. Data related to the initial drop-off destination is received. The data comprises event data corresponding to the initial drop-off destination and data corresponding to one or more passenger profiles. A suitability score for the initial drop-off destination is determined based on the data. The suitability score corresponds to a riskiness of dropping-off the one or more passengers at the initial drop-off destination. The suitability score is compared to a pre-determined suitability threshold. When the comparison indicates that the initial drop-off destination is unsuitable, an area bounding the initial drop-off destination, where unsuitable conditions exist is determined, based on the event data. At least one alternate drop-off destination is determined based on the area bounding the initial drop-off destination. A selection of one of the at least one alternate drop-off destinations for dropping-off the one or more passengers is received.

In various embodiments, the predetermined threshold is based on at least one of safety standards, regulations, and passenger preferences.

In various embodiments, the event data is based on at least one of news data, social media data, v2X data, IoT data, and CCTV data.

In various embodiments, data corresponding to one or more passenger profiles comprises at least one of a passenger's age, a passenger's medical condition, and a passenger's occupation.

In various embodiments, the method further comprises determining the suitability score for the initial drop-off destination which comprises determining the suitability score for the initial drop-off destination as the vehicle proceeds towards the initial drop-off destination.

In various embodiments, the method further comprises determining a subsequent suitability score for the selected one of the at least one alternate drop-off destinations, wherein the subsequent suitability score is based at least on a distance of the selected one of the at least one alternate drop-off destinations and the initial drop-off destination.

In various embodiments, a system is provided. The system comprises a computing node comprising a computer readable storage medium having program instructions embodied therewith. The program instructions are executable by a processor of the computing node to cause the processor to perform a method comprising the following steps. An initial drop-off destination is received. Data related to the initial drop-off destination is received. The data comprises event data corresponding to the initial drop-off destination and data corresponding to one or more passenger profiles. A suitability score for the initial drop-off destination based on the data is determined. The suitability score corresponds to a riskiness of dropping-off the one or more passengers at the initial drop-off destination. The suitability score is compared to a pre-determined suitability threshold. When the comparison indicates that the initial drop-off destination is unsuitable, an area bounding the initial drop-off destination, where unsuitable conditions exist is determined, based on the event data. At least one alternate drop-off destination is determined based on the area bounding the initial drop-off destination. A selection of one of the at least one alternate drop-off destinations for dropping-off one or more passengers is received.

In various embodiments, the predetermined threshold is based on at least one of safety standards, regulations, and passenger preferences.

In various embodiments, the event data is based on at least one of news data, social media data, v2X data, IoT data, and CCTV data.

In various embodiments, data corresponding to one or more passenger profiles comprises at least one of a passenger's age, a passenger's medical condition, and a passenger's occupation.

In various embodiments, determining the suitability score for the initial drop-off destination comprises determining the suitability score for the initial drop-off destination as the vehicle proceeds towards the initial drop-off destination.

In various embodiments, the method further comprises determining a subsequent suitability score for the selected one of the at least one alternate drop-off destinations, wherein the subsequent suitability score is based at least on a distance of the selected one of the at least one alternate drop-off destinations and the initial drop-off destination.

In various embodiments, a computer program product for dropping-off one or more passengers of an autonomous vehicle is provided. The computer program product comprises a computer readable storage medium having program instructions embodied therewith. The program instructions are executable by a processor to cause the processor to receive an initial drop-off destination. The processor receives data related to the initial drop-off destination. The data comprises event data corresponding to the initial drop-off destination and data corresponding to one or more passenger profiles. The processor determines a suitability score for the initial drop-off destination based on the data. The suitability score corresponds to a riskiness of dropping-off the one or more passengers at the initial drop-off destination. The suitability score is compared to a pre-determined suitability threshold. When the comparison indicates that the initial drop-off destination is unsuitable, an area bounding the initial drop-off destination, where unsuitable conditions exist is determined, based on the event data. At least one alternate drop-off destination is determined based on the area bounding the initial drop-off destination. A selection of one of the at least one alternate drop-off destinations for dropping-off one or more passengers is received.

In various embodiments, the predetermined threshold is based on at least one of safety standards, regulations, and passenger preferences.

In various embodiments, the event data is based on at least one of news data, social media data, v2X data, IoT data, and CCTV data.

In various embodiments, data corresponding to one or more passenger profiles comprises at least one of a passenger's age, a passenger's medical condition, and a passenger's occupation.

In various embodiments, the program instructions executable by a processor further cause the processor to determine the suitability score for the initial drop-off destination as the vehicle proceeds towards the initial drop-off destination.

### BRIEF DESCRIPTION OF THE DRAWINGS

FIG. 1 is a graphic depicting a vehicle dropping off a passenger at a suitable destination, in accordance with various embodiments of the present disclosure.

FIG. 2 depicts a flowchart illustrating a method for assessing a drop off destination, in accordance with various embodiments of the present disclosure.

FIG. 3 depicts a flowchart of an exemplary method of identifying an incident at a drop-off destination and the resulting suitability score and/or unsuitability score, based on the incident data and passenger profile data, in accordance with various embodiments of the present disclosure.

FIG. 4 depicts a flowchart of an exemplary method for evaluating the suitability score of a drop-off destination and searching for an alternate drop-off destination, in accordance with various embodiments of the present disclosure

FIG. 5 depicts a flowchart of an exemplary method for determining a destination for dropping-off one or more passengers of an autonomous vehicle, in accordance with various embodiments of the present disclosure.

FIG. 6 depicts a computing node according to various embodiments of the present disclosure.

### DETAILED DESCRIPTION

During passenger travel in autonomous vehicles, unforeseen incidents, which were not anticipated at the time of booking or travel, can occur at the destination before the passenger arrives. These unexpected incidents, such as medical emergencies, security threats, natural disasters, or crime, can make the destination unsuitable for dropping off of the passenger. Passengers may feel uncomfortable or unsafe arriving at destinations where an unexpected incident has just occurred. This discomfort and danger may be further accentuated if the passenger is unfamiliar with the destination. Thus, it is important to ensure passenger safety and preparedness. Proactive measures, such as risk assessment, contingency planning, and providing access to emergency support services at destinations can alleviate danger or discomfort experienced by passengers at destinations where unsafe incidents occur. However, dropping passengers off at alternative destinations can help passengers to avoid dangerous or uncomfortable situations altogether.

During autonomous vehicle navigation, ensuring passenger safety and convenience at the drop-off destination is an important feature. However, potential approaches lack comprehensive real-time assessment of the suitability and safety of drop-off destinations, exposing passengers to unsafe conditions. Thus, there exists a need in the art for a solution that addresses the need for an intelligent system that evaluates drop-off destinations in real-time by considering various factors such as incidents, infrastructure data, and passenger profiles, to provide safe and convenient alternative drop-off destinations when necessary.

In various embodiments, the systems and methods described herein may function within a “smart city”. A smart city is an urban center where technology and data collection improve the quality of life, sustainability, and efficiency of city operations. These centers implement technologies to collect data regarding the events occurring within the city. These technologies include a variety of sensors and data gathering devices for monitoring various areas. These devices may be connected to the Internet of Things (IoT) to share collected information across organizations and users. For example, data regarding the weather conditions, traffic patterns, and police activity may all be recorded in smart city monitoring systems. In smart cities, the data collected may be uploaded to a cloud computing platform by the government and shared to the public via WiFi or wireless connectivity.

The systems and methods described herein may enable autonomous vehicles to assess drop-off destination suitability by integrating real-time news, incidents, and IoT data. The suitability of a drop-off destination may correspond to a riskiness of dropping-off the one or more passengers at the drop-off destination. The system may offer alternative drop-off destinations if the current one is unsuitable, prioritizing passenger safety. Continuous assessment may ensure prompt action if unsuitability exceeds a predetermined threshold or suitability is below the threshold. Passenger profiles may be considered for personalized evaluations of drop-off destination suitability.

Once a drop-off destination is provided to the autonomous vehicle (by the passenger) for any journey, the vehicle may receive various real-time news/incidents, IoT and CCTV camera feeds from surrounding infrastructure, and V2X data from areas surrounding the drop-off destination to evaluate the suitability of the destination for passengers. If the drop-off destination is considered unsuitable for the passenger, the vehicle may search for an alternative drop-off destination in the location surrounding the passenger-provided drop-off destination for presentation to the passenger.

The systems and methods described above may involve the passenger providing a drop-off destination to the autonomous vehicle. The vehicle may then identify whether situations exist at the drop-off destination that are unsuitable for passengers. A situation may refer to the events, such as incidents, occurring at a destination, which may make the destination suitable or unsuitable for a passenger to be dropped off by the vehicle. For example, if there is an incident such as a robbery occurring at a destination, this may make the situation at the destination unsuitable for dropping off a passenger. The autonomous vehicle may also determine a surrounding area within a boundary around the drop-off destination where unsuitable conditions exist. The destinations within the boundary may be classified as unsuitable for drop-offs and given a suitability score (e.g., a low suitability score) and/or an unsuitability score (e.g., a high unsuitability score), then the vehicle may identify alternate drop-off destinations for the passenger to ensure the passenger is not impacted by the unsuitable conditions.

As used herein, a suitability score may be a positive whole or real number or a textual cue, and may correspond to a riskiness of dropping-off the one or more passengers at the drop-off destination. For example, and without limitation, the suitability score may range from 1-10 or may be a percentage from 1-100%. The suitability score may be a textual cue, such as “good”, “fair”, “poor”. Different destinations may be assigned different suitability scores based on the situation/incidents occurring there. For example, a lower suitability score may indicate that a destination is riskier or less suitable while a higher suitability score may indicate that a destination is less risky and more suitable.

Likewise, an unsuitability score may also be a positive whole or real number or a textual cue, and may correspond to a riskiness of dropping-off the one or more passengers at the drop-off destination. For example, and without limitation, the unsuitability score may range from 1-10 or may be a percentage from 1-100%. The unsuitability score may be a textual cue, such as “good”, “fair”, “poor”. A lower unsuitability score may indicate that a destination is less risky and more suitable while a higher unsuitability score may indicate that a destination is riskier or less suitable.

While the autonomous vehicle proceeds to the drop-off destination, it may continuously assess a suitability score (or unsuitability score) of the drop-off destination provided by the passenger. In various embodiments, a suitability (or unsuitability) score may be computed through a defined mathematical formula. In various embodiments, a suitability (or unsuitability) score may be computed by a computer algorithm, such as one included in a machine learning model using historical event data. In various embodiments, the suitability (or unsuitability) score may be computed through a logical method (e.g., if-then steps). If the suitability score (or unsuitability score) of the passenger-provided drop-off destination is beyond a predetermined threshold (e.g., the unsuitability score exceeds a threshold of unsuitability or the suitability score is below a threshold of suitability), the vehicle may immediately initiate a search for alternate drop-off destinations. Once alternate drop-off destinations with suitability scores that are not beyond (e.g., below) a suitability threshold (or with unsuitability scores that are not beyond an unsuitability threshold) are identified, the vehicle may notify the passenger and request that he/she selects an alternate drop-off destination. In various embodiments, instead of having a passenger select an alternate drop-off destination, the vehicle may automatically select an alternate drop-off destination, based on available destination data, scores, passenger profile data, and/or the like. The travel route may then be adjusted to proceed to the selected alternate drop-off destination to ensure that passengers are not impacted by the identified unsuitable situation at the original drop-off destination. The autonomous vehicle may also determine the suitability of a destination, and a suitability or an unsuitability score, based on one or more passenger profiles, such as a profile of a passenger riding within the autonomous vehicle. Each passenger profile may include data regarding the passenger's age, medical conditions, occupation, purpose of their travel, and/or any other internally or externally known characteristic of the passenger. In various embodiments, the same situation at the same drop-off destination (e.g., incidents occurring at the destination) may result in different suitability or unsuitability scores for two different passengers when each passenger's profile is considered. Additionally, the autonomous vehicle may use each passenger's profile data when determining alternate drop-off destinations.

If real-time news data regarding a drop-off destination is not received and provided, the autonomous vehicle system may consider other information to determine a suitability or an unsuitability score. This information may include information such as the last available news about the drop-off destination, historical data regarding the destination, real-time information geo-tagged on social media, patterns in changes in nearby telephonic tower usage, etc. This information may be used to determine the suitability or the unsuitability score of the drop-off destination and to possibly initiate a search for an alternate drop-off destination.

Depending on the suitability and/or unsuitability score of the drop-off destination, the distance of an alternate, safe, drop-off destination from the passenger-provided drop-off destination, and/or real-time information regarding the status of the drop-off destination, the autonomous vehicle may notify the passenger of various possible options. For example, these options may include alternate drop-off destinations, the option to delay/postpone travel, and/or the option to cancel travel.

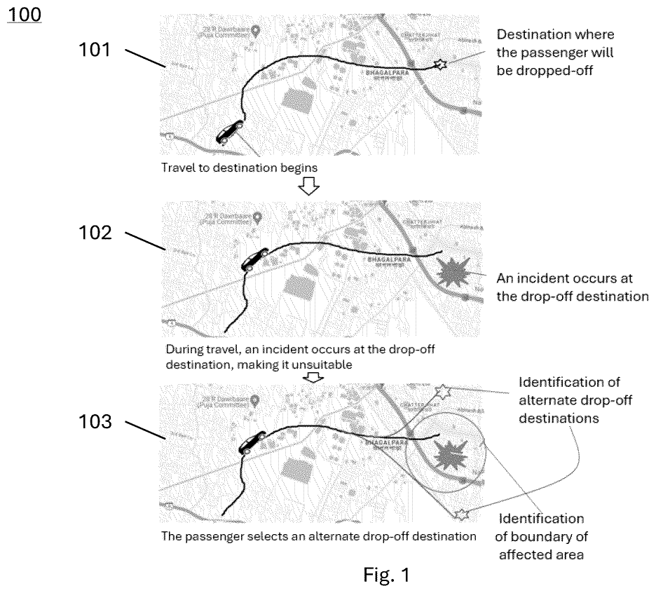

Referring now to FIG. 1 a graphic 100 of a vehicle dropping off a passenger at a suitable destination is depicted.

In panel 101, a passenger may provide the autonomous vehicle with a drop-off destination. The autonomous vehicle may receive this information and begin route to the passenger specified destination. As the autonomous vehicle proceeds to the destination, it may simultaneously monitor the suitability and safety of the destination continuously. For example, and without limitation, when there is an incident, as shown in panel 102, which may also be referred to as a situation, such as an explosion, robbery, or physical incident, at or around the destination, the autonomous vehicle may determine a suitability and/or an unsuitability score for the destination. If the determined suitability score (or unsuitability score) is beyond (e.g., below) a pre-determined threshold, the vehicle may identify suitable alternative drop-off destinations. The vehicle may be able to identify a boundary of an entire region, surrounding the initial drop-off destination, affected by the incident in order to suggest alternate destinations as shown in panel 103. The vehicle may provide these alternative destinations to the passenger, such as via a visual display within the vehicle. The passenger may select one of the alternate drop-off destinations, and the vehicle may proceed to the accepted alternate drop-off destination.

In various embodiments, the passenger may supply drop-off destination information or select an alternative drop-off destination on a user input device, which may be a touchscreen provided in the interior of the autonomous vehicle. In various embodiments, the passenger may supply drop-off destination information or select an alternative drop-off destination on a ride-share app on a mobile phone, which may transmit this information to the autonomous vehicle, and may function as the user input device.

In various embodiments, the autonomous vehicle may operate within one or more smart cities and determine the suitability and/or safety of a drop-off destination by analyzing CCTV and IoT camera feeds, V2X data, real-time news, and/or the like. In various embodiments, the autonomous vehicle may not operate within one or more smart cities and may determine the suitability and/or safety of a drop-off destination by analyzing real-time news, V2X data, and/or the like.

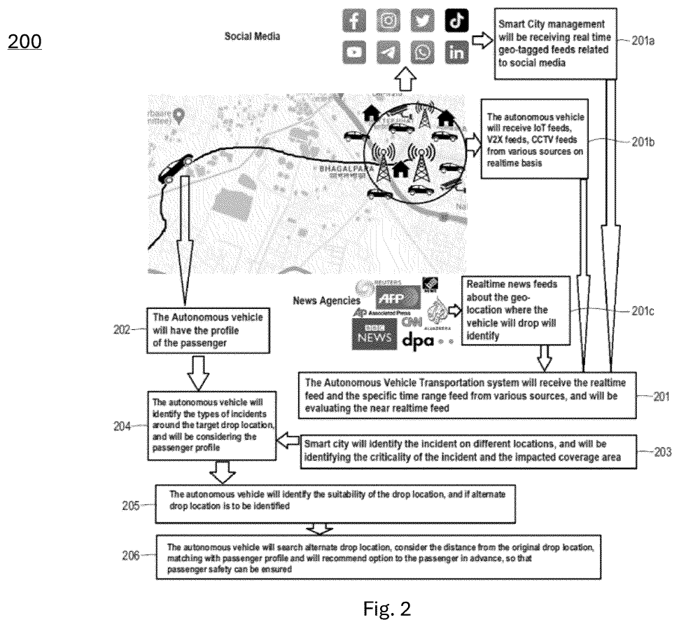

Referring now to FIG. 2, a flowchart of a method 200 for assessing a drop off destination is depicted. An autonomous vehicle may first receive a drop-off destination from a passenger and may subsequently determine the vehicle's current location, distance from the drop-off destination, estimated time of travel to reach the destination, for example using GPS receiver(s) located within the vehicle.

At step 201, the autonomous vehicle may receive information regarding drop-off destinations from various sources. The autonomous vehicle may receive geo-tagged social media feeds at step 201a. Social media feeds may include information posted by netizens regarding events occurring at a drop-off destination chosen by the passenger. Written text as well as video footage and captured images related to drop-off destinations may all be social media feed data transmitted to an autonomous vehicle. In various embodiments, this data may be used to determine a suitability or an unsuitability score for a drop-off destination.

At step 201b, the vehicle may also receive IoT feeds, V2X feeds, and CCTV camera feeds from various sources, for example, on a real time basis. In various embodiments, any data received from these feeds may be used to determine a suitability or an unsuitability score for a drop-off destination. V2X feeds may include information gathered from a GPS system or any variety of sensors mounted on the autonomous vehicle, such as LiDAR sensors or radar. An autonomous vehicle may be able to determine unsafe or unsuitable situations and destinations using the data from the feeds. For example and without limitation, when no other data is available, an autonomous vehicle may be able to sense smoke from a fire or unusual audio cues using sensors or a microphone mounted on the vehicle. In a smart city, an autonomous vehicle may be capable of accessing CCTV footage. In a smart city, autonomous vehicles may access an electric grid map of the city to identify various infrastructures having geo-tagged CCTV camera feeds. In various embodiments, the vehicle may be capable of carrying out video footage analysis techniques in order to identify the timing of posts and the different types of incidents occurring in each video feed, such as a CCTV camera feed. In various embodiments, information uploaded via IoT device(s) or received via IoT feeds may also be accessed by the vehicle, such as data regarding traffic patterns, police activity, or public events.

At step 201c, the vehicle may receive real time news feeds from various media sources. In particular, autonomous vehicle service providers may have API integration with various news services and may receive news feeds from local agencies. The news APIs, such as those provided by news agencies or platforms, such as Google News™, may gather real-time news updates for use by the vehicle in determining a suitability or an unsuitability score for a drop-off destination, for example. Additionally, real-time TV news data may also be received by the vehicle and considered for use in determining a suitability or an unsuitability score for a drop-off destination. The information gathered in steps 201a-c may also be stored by the vehicle as historical data for future use in determining a suitability or an unsuitability score for a drop-off destination.

In various embodiments, the autonomous vehicle may receive information from all of the above-mentioned feeds and sources. In various embodiments, the autonomous vehicle may receive data from fewer than all of the above-mentioned fees and sources. In various embodiments, no real-time data may be available and the vehicle may rely on historical data, such as, data regarding past drop-off destinations.

At step 202, the vehicle may receive a passenger profile for each passenger in the vehicle. Each passenger profile may include data regarding the age, occupation, medical history, and/or any other internal or external characteristic of the passenger. In various embodiments, this information may be used to determine whether a drop-off destination is suitable and/or safe for the passengers. For example, if a passenger is an elderly person with a history of respiratory illness, the vehicle may determine that the passenger should not be dropped off at a destination where air pollution levels are high. In contrast, if a younger passenger with no medical illnesses is traveling in the vehicle, the vehicle may determine that it is acceptable to drop off the passenger at the same destination.

In various embodiments, a passenger may add their profile information when they enter the vehicle on a touchscreen mounted inside the vehicle, or via their mobile phone, which may connect with the vehicle. In various embodiments, the passenger may have a stored passenger profile on an autonomous vehicle ride-sharing app, which may be shared with the vehicle. For example, when the passenger requests a ride via the ride-sharing app, the profile may be shared with the vehicle that will transport the passenger.

At step 203, the vehicle may analyze the incident information collected from one or more of steps 201a-c using pattern-based or rule-based techniques to extract structured information about events, such as incidents, including the type of incident, time, location, and involved entities. Based on this information, the vehicle may classify the events into identified categories (e.g., accidents, crimes, emergencies), identify the risks associated with each incident, and determine what boundary/radius around the destination, such as the initial drop-off destination input by a passenger, may also be impacted. A boundary around an impacted destination may be determined based on the information that is gathered/received by the vehicle. For example, and without limitation, when high air pollution levels are determined at an initial drop-off destination, the vehicle may determine whether additional destinations surrounding the initial destination are also impacted by high pollution levels. The vehicle may be able to use air pollution data at these additional destinations to determine a boundary or may be able to determine which additional destinations may likely have higher air pollution levels based on the data from the initial drop-off destination.

In various embodiments, different events, such as incidents, may be given different criticality ratings. For example, and without limitation, reports of a fire may be given a higher criticality rating than reports of shop-lifting. Based on such information, the vehicle may also determine the impacted coverage area of the event. The coverage area of the event may correspond to a boundary/radius around the location of the event, as described herein. For example, the fire would likely impact a much larger area compared to a shop-lifting incident, which would likely affect a very localized area. The impacted coverage areas of different events may also affect the assigned criticality ratings of a specified destination. Larger impacted coverage areas may correspond to higher criticality ratings and smaller impacted coverage areas may correspond to lower criticality ratings.

In various embodiments, the vehicle may be capable of assigning different criticality ratings to different regions of the identified boundary/radius around the location of the event.

The criticality ratings may be based on any rating system, where a higher value may be associated with a higher criticality rating and a lower value may be associated with a lower criticality rating. In various embodiments, the criticality rating may be a numerical score, such as a whole number or a percentage. For example, and without limitation, a criticality rating may fall within a range of 1-10, where a score of 10 indicates a very high criticality rating and unsafe conditions and a score of 1 indicates the lowest criticality rating and relatively safe conditions. In various embodiments, the criticality rating may be a verbal/textual cue. For example, and without limitation, the criticality ratings may include cues such as “low”, “medium”, “high”, and “extreme”.

In various embodiments, the autonomous vehicle may be capable of identifying locations referenced in news articles and/or incident reports, which it receives, by implementing Named Entity Recognition techniques. The vehicle may extract geo-locations referenced in the news articles or incident reports to associate events, such as incidents, with specific areas within a smart city to build an event map, such as an incident map.

In various embodiments, when analyzing the news articles or incident reports, the autonomous vehicle may use natural language processing methods (NLP), known in the art, to extract relevant keywords from news articles and/or incident reports and assign appropriate criticality ratings to events, referenced in the news articles and/or incident reports, based on the keywords. Such processes may be carried out on articles or reports originating from the vicinity of a drop-off destination. When a passenger requests a ride, the vehicle may identify the drop-off destination and a specified boundary range/vicinity of the drop-off destination (where the passenger would prefer to be dropped-off). The vehicle may start gathering recent news regarding the drop-off destination and the surrounding area specified by the boundary range/vicinity. In various embodiments, the specified boundary range/vicinity of the drop-off destination may be a set radius. In various embodiments, the boundary range/vicinity of a drop-off destination may be automatically identified by the vehicle upon analysis of the collected data or set by the passenger.

In various embodiments, the vehicle may be capable of using topic modeling algorithms to identify topics or themes within the received news articles and/or incident reports for a particular location corresponding to a possible drop-off destination. If the vehicle is able to determine that incidents occurring at the particular location match the drop-off destination specified by the passenger, a sentiment analysis may be performed on the gathered data. The sentiment expressed in news articles and/or incident reports, towards specific events, such as incidents, and/or specific locations, may be used to understand public perception and response to events. The sentiment identified in the data may affect the criticality ratings, which may be reflective of a relative risk to the passenger at a location corresponding to any drop-off destination(s). The data analyzed in this step may also be stored for further analysis as historical data.

In various embodiments, the autonomous vehicle may also implement machine learning (ML) models based on historical data to predict the likelihood of events, such as incidents, occurring in specific areas. This can assist the vehicle in prioritizing news feeds and incident reports relevant to a drop-off destination.

At step 204, the vehicle may consolidate all the data received at steps 201, 202, and/or 203. Based on each passenger's profile data in conjunction with the event data, such as incident data, and criticality ratings, the vehicle may determine a suitability score for the passenger-provided drop-off destination. The suitability score and/or unsuitability score may be computed in a variety of ways. In various embodiments, numerical values may be assigned to aspects of each passenger's profile data and the event data. In various embodiments, a weighted computation may be performed in order to obtain a suitability score and/or unsuitability score. In various embodiments, textual cues may be assigned to aspects of each passenger's profile data and the incident data. A logical methodology may allow for the translation of a suitability and/or unsuitability score into a textual cue. For example, and without limitation, aspects of a passenger's profile data may include different risk cues. A passenger with a mobility impairment may have a “high” risk cue included in their passenger profile. On the other hand, the situation (e.g., incidents occurring at the destination) at a drop-off destination may have low or no criticality ratings when no events are occurring there. A series of if-then steps may be carried out to determine that the suitability score is not beyond a predetermined threshold (e.g., below) or “acceptable/good” for the passenger in this scenario.

At step 205, the vehicle may determine whether the suitability score and/or unsuitability score, determined at step 204, is beyond a predetermined threshold (e.g., at or below, or above) or not. If the suitability score is not beyond (e.g., below) a predetermined suitability threshold, then the vehicle may proceed to drop the passenger off at a destination corresponding to the drop-off destination they had initially specified. Similarly, if the unsuitability score is not beyond (e.g., above) a predetermined unsuitability threshold, then the vehicle may proceed to drop the passenger off at a destination corresponding to the drop-off destination they had initially specified.

In various embodiments, if a suitability score computed at step 204 is beyond (e.g., below) the pre-determined suitability threshold and/or if an unsuitability score computed at step 204 is beyond (e.g., above) the pre-determined unsuitability threshold, then the vehicle may automatically search for alternate drop-off destinations in the area surrounding the passenger-specified drop-off destination at step 206. In various embodiments, the vehicle may present these alternate destinations to the passenger via a display, such as via a touchscreen inside the vehicle or via a ride-sharing app shown on a display of the passenger's mobile device. When the passenger accepts an alternate drop-off destination, the vehicle may proceed to the location associated with the alternate drop-off destination.

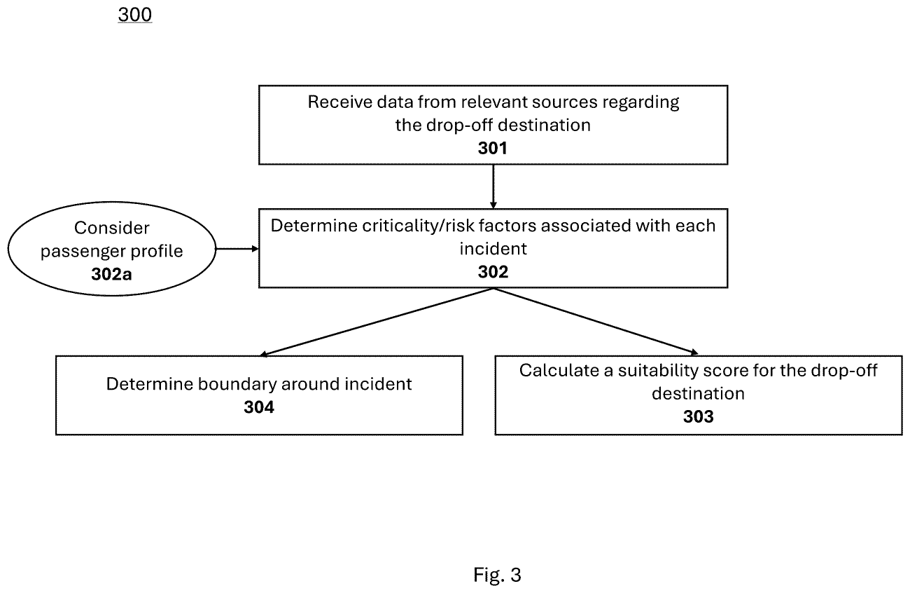

Referring now to FIG. 3, a flowchart of an exemplary method 300 of identifying an incident at a drop-off destination and the resulting suitability score and/or unsuitability score, based on the incident data and passenger profile data, is depicted.

At step 301, as described herein, an autonomous vehicle may receive incident data from various sources (e.g., social media, news reports, CCTV, IoT, etc.) for the area surrounding a drop-off destination, such as one initially provided by a passenger of the vehicle or a subsequently determined or selected alternate drop-off destination. The vehicle may use this data to assess the nature and severity of the identified incident (e.g., accidents, crimes, natural disasters). Relevant information about the incident, including its location, time, and impact may also be gathered at 301. The vehicle may classify the data based on the type of incident and its criticality using topic modeling methods and/or smart city management norms (i.e., if the vehicle is operating in a smart city). This data may also inform the vehicle about how much of the area surrounding the drop-off destination is considered critical/risky and should be avoided.

At step 302, the vehicle may identify criticality/risk factors at identified incidents at the drop-off destination based on data received in incident reports at 301. For example, and without limitation, if a fire is identified at the drop-off destination, the vehicle may be able to identify criticality/risk factors such as high smoke levels, increased temperatures, etc. and assign criticality ratings to each. Criticality/risk factors may include a corresponding criticality rating based on the vehicle's perception of the riskiness associated with each factor. In various embodiments, criticality ratings may be numerical values. In various embodiments, a criticality factor that is perceived to be riskier may be assigned a higher criticality rating, and a criticality factor that is perceived to be less risky may be assigned a lower criticality rating. Once criticality ratings are determined, they may be used to compute a suitability score. For example, and without limitation, if the identified incident is a robbery, the vehicle may identify an armed person as a criticality/risk factor and assign a corresponding high criticality rating. In various embodiments, criticality ratings may be assigned by an ML model, which may use past, historical event data to determine the effects of certain incidents, their impact, and their riskiness. In various embodiments, if the vehicle is operating in a smart city, there can be defined rules for assessing a suitability and/or unsuitability score for different types of passengers, identifying risk factors, and defining boundaries around an incident location. Some smart cities may categorize incidents by risk, reducing the need for the vehicle to determine its own set of rules governing the suitability of drop-off destination.

In various embodiments, criticality ratings for particular criticality/risk factors may be pre-defined and unchanging. In other words, particular identified criticality factors may automatically carry pre-determined criticality ratings of pre-set values. In various embodiments, the criticality/risk factors may be partially assessed by a passenger. For example, when the vehicle identifies an incident at the drop-off destination and associated criticality/risk factors, the vehicle may present such factors to the passenger. The passenger may then rate each factor to convey their belief regarding the risk level of each factor. The ratings can then be used in the computation of the suitability and/or unsuitability score.

The passenger profile data may be another factor used in determining the suitability and/or unsuitability score in 302a. When a passenger(s) onboards in the vehicle, the vehicle will receive the passenger profile(s) data associated with the passenger(s). As disclosed herein, different factors such as age, health condition, mobility, vulnerability, occupation/profession of a passenger may be stored in a passenger profile. Such data may provide the vehicle information regarding a passenger's identity/status (e.g., whether the passenger is a regular commuter, elderly or disabled passengers, children or minors, tourists or visitors).

In various embodiments, the vehicle will analyze the criticality/risk factors and/or ratings associated with any incident type at a drop off destination. The vehicle may also analyze characteristics of each of its passengers based on passenger profile(s). The vehicle may perform such analyses using historical patterns, predefined rules, metrics, and/or formulas, machine learning models, and/or the like. For example, and without limitation, based on the analyses that it performs, the vehicle may determine that elderly passengers may have difficulty evacuating the vehicle, children may be more susceptible to injuries, and that passengers with mobility impairments may require assistance in vehicle evacuation.

Based on the above-mentioned data and analyses, the vehicle may implement a suitability and/or unsuitability score computation technique at 303 for the drop-off destination. In performing this computation, the vehicle may account for the criticality/risk factors associated with any incident, the proximity of any incident to the drop-off destination, and/or passenger information, such as passenger vulnerability.

As described above, in various embodiments, the suitability score and/or unsuitability score may be determined by a mathematical computation performed by the vehicle. In various embodiments the computation may be based on the identified risk/criticality factors, criticality ratings, and/or aspects of the passenger profile data. In various embodiments, the suitability score and/or unsuitability score may be a discrete value or a continuous value. In various embodiments, as disclosed herein, the suitability score and/or unsuitability score may be computed using a defined formula. In various embodiments, as disclosed herein, the suitability score and/or unsuitability score may be computed by a ML model. For example, and without limitation, to compute a suitability score(s) and/or unsuitability score(s), each criticality factor may be assigned a corresponding criticality score (a value from 1-10) based on riskiness of the factor as perceived by the vehicle. For example, if the incident is a robbery and the criticality factor is an armed individual, a relatively high criticality score may be assigned. In this example, each aspect of the passenger profile may also be assigned a value from 1-10. The vehicle may assign a value for the passenger's age, medical condition, and/or any other characteristic of the passenger. Continuing with the example, the older the passenger is, the higher the value may be for the assigned age value. If a passenger has a history of multiple medical conditions, the assigned value for the passenger's health may be relatively high. The vehicle may then compile these values and take a weighted average to obtain a suitability score and/or unsuitability score. In various embodiments, the weights assigned to each value maybe pre-determined and/or pre-set. In various embodiments, the weights assigned to each value may be selected by a vehicle system designer and/or a user.

For example, and without limitation, an incident, such as a fire, may be identified at a drop-off destination by a computing system associated with a vehicle. The identified criticality factors associated with the fire may be increased temperatures and smoke levels. Based on the information extracted from the event data (articles, videos, news feed), a ML model may assign each criticality factor a criticality rating. NLP techniques and sentiment analysis may be performed on each of the event data to determine the riskiness/criticality associated with each criticality factor. Each of the factors may be given a criticality rating from 1-10 (or any other normalized range of numerical values) based on the event data that is received regarding the fire. The more smoke that is produced or the higher the temperature of the area, the higher the criticality rating may be for that criticality factor. In this example, a passenger profile may then be analyzed by the system. An elderly passenger may be assigned a value based on their age. If the passenger has a history of respiratory illness, a value may be assigned for their medical condition. The assigned values for the passenger profile may be normalized numerical values, such as values ranging from 1-10. To compute the suitability score, each criticality rating may be multiplied by a normalized numerical weight, such as (0.1, 0.2, 0.3, etc.), and a sum may be computed as shown in the following formula:

$$Suitability score = weight I \times ( criticality factor I ) + weight II \times ( criticality factor II ) + weight III ( passenger profile assigned value I ) + weight IV \times ( passenger profile assigned value II ) .$$

In various embodiments, the suitability score or unsuitability score formula(s) may be expressed as continuous function, such as in a probability density function or a differential equation. For example, the vehicle may use the criticality scores and passenger profile data to model the suitability score as a probability density function. This could allow the suitability score to be expressed as a probability. The suitability score expressed as a probability may indicate the likelihood that a drop-off destination would be unsuitable for a passenger, which may be valuable when real-time data regarding a drop-off destination is not available. As another example, the vehicle may use the criticality scores and passenger profile data to model the suitability score as a differential equation. Such use of a differential equation would allow the vehicle to model the predicted changes in the suitability score over time.

In various embodiments, the suitability score and/or unsuitability score may be computed by any other suitable mathematical or logical methods.

In various embodiments, while the vehicle determines a suitability score, the vehicle may be capable of concurrently determining defined boundaries around the incident location based on the assessed criticality/risk factors determined at 304. In various embodiments, a dynamic risk assessment may be performed by the vehicle to consider real-time data updates and changes in any incident's impact and to continuously monitor the incident and its surrounding area for any developments or changes in risk factors.

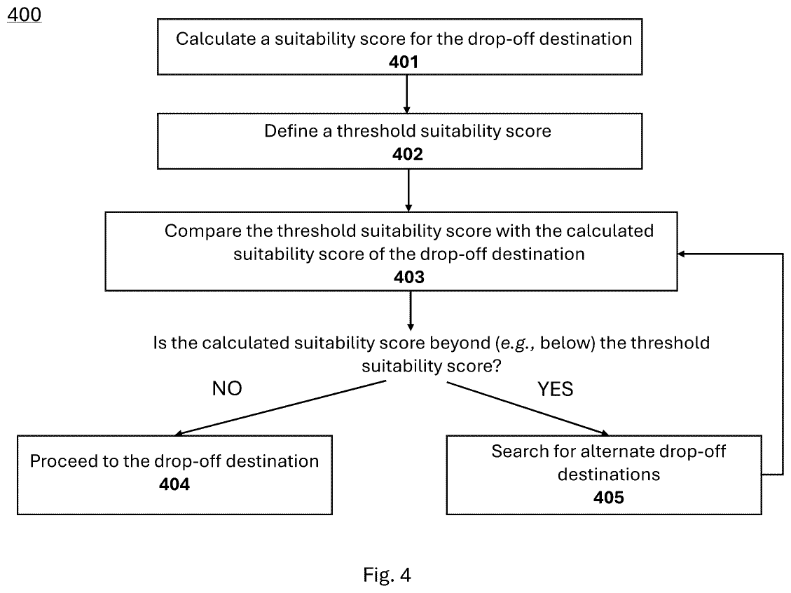

Referring now to FIG. 4, a flowchart of an exemplary method 400 for evaluating the suitability score of a drop-off destination and searching for an alternate drop-off destination, is depicted.

At step 401, an autonomous vehicle will continuously evaluate a suitability score and/or unsuitability score corresponding to the drop-off destination defined by the passenger(s).

In various embodiments, as disclosed herein, the vehicle may determine a suitability score and/or unsuitability score to quantify the suitability of the drop-off destination, for example, based on the analyzed criticality factors, their respective ratings, and the passenger profile. In various embodiments, the suitability score and/or unsuitability score corresponding to the drop-off destination can be received from a smart city. In various embodiments, when it is determining the score(s), the vehicle may also account for activity that occurs after the incident happens. The data received regarding the activity that occurs after an event, such as an incident, occurs can also be stored as historical data and used in historical learning processes. In various embodiments, the suitability score and/or unsuitability score may be computed based on the data received on a real-time basis. In various embodiments, the suitability score and/or unsuitability score may be computed based on historical data. Using ML techniques, the vehicle may be able to use stored historical data to predict incidents that tend to occur at certain locations and/or destinations.

In various embodiments, a threshold suitability score (or a threshold unsuitability score) may be pre-determined. In various embodiments, a threshold suitability score (or a threshold unsuitability score) may be determined on-line, such as when a vehicle is operating. In various embodiments, a threshold suitability score (or a threshold unsuitability score) may be determined by the vehicle. FIG. 4 depicts an embodiment of the method for evaluating a suitability score wherein the threshold suitability score may be determined by the vehicle. At step 402, the vehicle may define a threshold suitability score, beyond which (e.g., below) a drop-off destination may be considered unsuitable for a passenger. For example, the computation of the threshold suitability score may take into account safety standards set by a smart city. If there is a fire, a smart city may define how big the fire must be or how much smoke must be produced before the fire is considered a threat to public safety. From this data, the vehicle may assign “threshold” criticality ratings for each of the specific criticality factors defined by the smart city (e.g., the amount of smoke produced and the size of the fire to be considered a threat to public safety). With the “threshold” criticality ratings and the values assigned to different aspects of the passenger profile, the vehicle may determine a threshold suitability score, based on any one of the methods described herein, such as what is shown and described in FIG. 3.

At step 403, the autonomous vehicle may compare the computed suitability score (or unsuitability score) with the threshold suitability score (or threshold unsuitability score). If the computed suitability score (or unsuitability score) is beyond (e.g., at or below) the threshold, then the vehicle will search for and determine one or more alternate drop-off destinations at 405. If the computed suitability score (or unsuitability score) is not beyond (e.g., at or below the threshold), the vehicle will proceed to the drop-off destination at 404.

As disclosed herein, in various embodiments, the vehicle may identify an affected radius and/or an affected area bounding an event, such as an incident, at the initial drop-off destination. In particular, this affected radius and/or affected area may indicate that the event makes any drop-off destination within the radius and/or area unsuitable for dropping off passenger(s). The vehicle may identify a one or more alternate outside the affected area. The vehicle may then perform a suitability score and/or unsuitability score computation on each of the identified alternate drop-off destinations to find an alternate drop-off destination with a suitability score (or unsuitability score) that is not beyond (e.g., below) the threshold suitability score value (or threshold unsuitability score value). In computing the suability score (or unsuitability score) for possible alternate drop-off destinations, the vehicle may take into account the same factors as in the computation of the suitability score (or unsuitability score) for the passenger-specified initial drop-off destination.

In various embodiments, the vehicle may also take into account factors such as the accessibility of each alternate drop-off destination and/or distance of each alternate drop-off destination to the passenger-specified initial drop-off destination in the computation of the suitability score (or unsuitability score) for each alternate drop-off destination. For example, if an alternate drop-off destination would be too far for passenger(s) to walk from the initial drop-off destination, the alternate drop-off destination may be deemed to have a suitability score (or unsuitability score) beyond (e.g., below) threshold suitability score (or threshold unsuitability score) and may not be suggested to the passenger(s). In another example, an alternate drop-off destination may be sufficiently close enough for passenger(s) to walk to the original initial drop-off destination and may be assigned a sufficiently high suitability score (or low unsuitability score); however, if there is an obstacle (e.g. fence, police blockade, etc.) between the initial and alternative drop-off destination, the suitability score (or unsuitability score) may be beyond (e.g., below) the threshold suitability score, and may not be suggested to the passenger(s). In considering alternate drop-off destinations, the vehicle may also take into account passenger(s) preferences and profile(s). For example, a passenger may specify, upon entering the vehicle, the maximum distance from the passenger-provided initial drop-off destination they would like to be dropped off at if an alternate destination is required. As another example, if a passenger profile indicates that a passenger has a mobility impairment, the radius and/or area in which the vehicle searches for alternate destination may be reduced to take into account the mobility impairment.

In various embodiments, the autonomous vehicle may include a dynamic decision-making algorithm that dynamically evaluates the suitability of potential drop-off destinations based on real-time data updates. Because news coverage, social media, v2X, IoT, and CCTV data is continuous, the vehicle may analyze this data as it is received. The surrounding environment at a drop-off destination may continuously be monitored for changes in conditions that may affect the suitability score and/or unsuitability score. For example, at the beginning of a ride, the suitability score of the passenger-specified initial drop-off destination may exceed the suitability score threshold. However, as the ride progresses the vehicle may continue to monitor the status of the initial drop-off destination. Based on data the vehicle receives, an incident occurring at the initial drop-off destination may be detected by the vehicle as it progresses, during its ride, towards the initial drop-off destination. The vehicle may continuously monitor and evaluate whether the initial drop-off destination is still suitable for dropping off passenger(s) during the ride. If the incident at the initial drop-off destination is resolved during the ride, the passenger may be dropped off at the initial drop-off destination. Alternatively, if the incident is not resolved during the course of the ride, and the vehicle determines that the initial drop-off destination is unsuitable for a drop-off, the vehicle may present suitable alternate drop-off destination(s) to the passenger. As discussed, the vehicle may present the alternate drop-off destination(s) to the passenger via a touchscreen inside the vehicle and/or through a ride-sharing app on the passenger's mobile phone. When the passenger approves of an alternate drop-off destination, the vehicle may proceed to that destination.

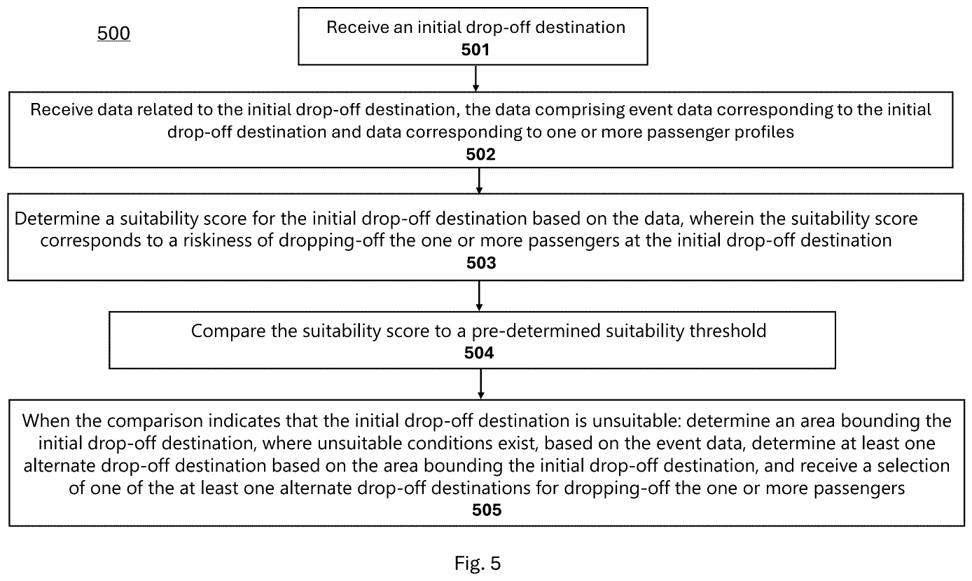

Referring to FIG. 5, a flowchart of a method 500 for determining a destination for dropping-off one or more passengers of an autonomous vehicle is depicted. At step 501, the vehicle may receive an initial drop-off destination. As disclosed herein, the initial drop off location may be received via a touch screen or app on a passenger's mobile device. At step 502, the vehicle may receive data related to the initial drop-off destination. The data received may comprise event data corresponding to the initial drop-off destination and data corresponding to one or more passenger profiles. At step 503, the vehicle may determine a suitability score for the initial drop-off destination based on the data. The suitability score may correspond to a riskiness of dropping-off the one or more passengers at the initial drop-off destination. At step 504, the vehicle may compare the suitability score to a pre-determined suitability threshold. At step 505, when the comparison indicates that the initial drop-off destination is unsuitable, an area bounding the initial drop-off destination, where unsuitable conditions exist may be determined, based on the event data. At least one alternate drop-off destination may be determined based on the area bounding the initial drop-off destination. The vehicle may receive a selection of one of the at least one alternate drop-off destinations for dropping-off the one or more passengers.

The operations of methods, presented above, are intended to be illustrative. In various embodiments, the methods are accomplished with one or more additional operations not described and/or without one or more of the operations discussed. Any of the operations of the methods above may be performed in any order, sequentially, and/or in parallel. Additionally, the order in which the operations of methods above are illustrated in their corresponding Figures and are not intended to be limiting.

In various embodiments, the methods described herein are implemented in one or more processing devices (e.g., a digital processor, an analog processor, a digital circuit designed to process information, a state machine, one or more computing nodes, and/or other mechanisms for electronically processing information). In various embodiments, the one or more processing devices may be located on-board or within the vehicle. In various embodiments, the one or more processing devices may be located outside of the vehicle. The one or more processing devices may include one or more devices configured through hardware, firmware, and/or software to be specifically designed for execution of one or more of the operations of any method.

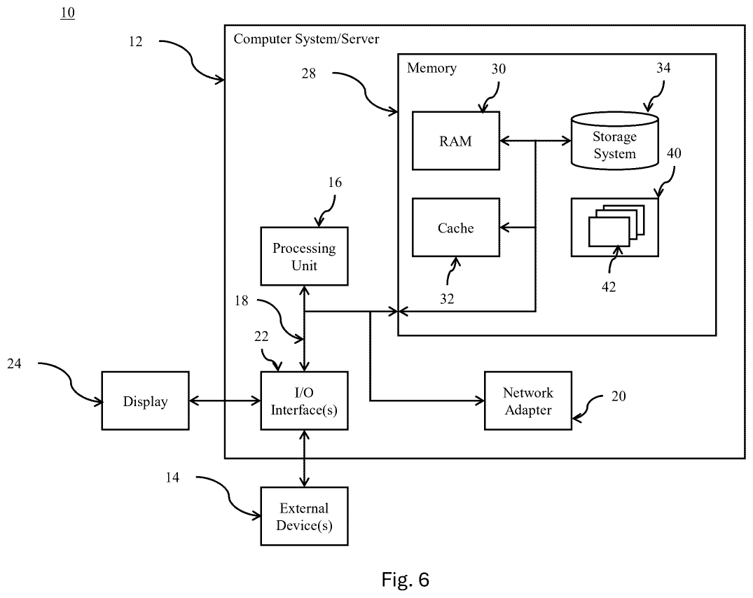

Although various methods of the present disclosure are identified as being performed by a vehicle, such as an autonomous vehicle, it is to be understood that these methods may be performed by any computing system or processing device associated with the vehicle, such as the computing node described herein. As shown in FIG. 6, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In various embodiments, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for determining a destination for dropping-off one or more passengers of an autonomous vehicle comprising:
receiving an initial drop-off destination;
receiving data related to the initial drop-off destination, the data comprising event data corresponding to the initial drop-off destination and data corresponding to one or more passenger profiles;
determining a suitability score for the initial drop-off destination based on the data, wherein the suitability score corresponds to a riskiness of dropping-off the one or more passengers at the initial drop-off destination;
comparing the suitability score to a pre-determined suitability threshold; and
when the comparison indicates that the initial drop-off destination is unsuitable:
determining an area bounding the initial drop-off destination, where unsuitable conditions exist, based on the event data,
determining at least one alternate drop-off destination based on the area bounding the initial drop-off destination, and
receiving a selection of one of the at least one alternate drop-off destinations for dropping-off the one or more passengers.

2. The method of claim 1, wherein the predetermined threshold is based on at least one of safety standards, regulations, and passenger preferences.

3. The method of claim 1, wherein the event data is based on at least one of news data, social media data, v2X data, IoT data, and CCTV data.

4. The method of claim 1, wherein data corresponding to one or more passenger profiles comprises at least one of a passenger's age, a passenger's medical condition, and a passenger's occupation.

5. The method of claim 1, wherein determining the suitability score for the initial drop-off destination comprises determining the suitability score for the initial drop-off destination as the vehicle proceeds towards the initial drop-off destination.

6. The method of claim 1, further comprising determining a subsequent suitability score for the selected one of the at least one alternate drop-off destinations, wherein the subsequent suitability score is based at least on a distance of the selected one of the at least one alternate drop-off destinations and the initial drop-off destination.

7. A system comprising:
a computing node comprising a computer readable storage medium having program instructions embodied therewith, the program instructions executable by a processor of the computing node to cause the processor to perform a method comprising:
receiving an initial drop-off destination;
receiving data related to the initial drop-off destination, the data comprising event data corresponding to the initial drop-off destination and data corresponding to one or more passenger profiles;
determining a suitability score for the initial drop-off destination based on the data, wherein the suitability score corresponds to a riskiness of dropping-off the one or more passengers at the initial drop-off destination;
comparing the suitability score to a pre-determined suitability threshold; and
when the comparison indicates that the initial drop-off destination is unsuitable:
determining an area bounding the initial drop-off destination, where unsuitable conditions exist, based on the event data,
determining at least one alternate drop-off destination based on the area bounding the initial drop-off destination, and
receiving a selection of one of the at least one alternate drop-off destinations for dropping-off one or more passengers.

8. The system of claim 7, wherein the predetermined threshold is based on at least one of safety standards, regulations, and passenger preferences.

9. The system of claim 7, wherein the event data is based on at least one of news data, social media data, v2X data, IoT data, and CCTV data.

10. The system of claim 7, wherein data corresponding to one or more passenger profiles comprises at least one of a passenger's age, a passenger's medical condition, and a passenger's occupation.

11. The system of claim 7, wherein determining the suitability score for the initial drop-off destination comprises determining the suitability score for the initial drop-off destination as the vehicle proceeds towards the initial drop-off destination.

12. The system of claim 7, wherein the method further comprises determining a subsequent suitability score for the selected one of the at least one alternate drop-off destinations, wherein the subsequent suitability score is based at least on a distance of the selected one of the at least one alternate drop-off destinations and the initial drop-off destination.

13. A computer program product for dropping-off one or more passengers of an autonomous vehicle, the computer program product comprising a computer readable storage medium having program instructions embodied therewith, the program instructions executable by a processor to cause the processor to:
receive an initial drop-off destination;
receive data related to the initial drop-off destination, the data comprising event data corresponding to the initial drop-off destination and data corresponding to one or more passenger profiles;
determine a suitability score for the initial drop-off destination based on the data, wherein the suitability score corresponds to a riskiness of dropping-off the one or more passengers at the initial drop-off destination;
compare the suitability score to a pre-determined suitability threshold; and
when the comparison indicates that the initial drop-off destination is unsuitable:
determine an area bounding the initial drop-off destination, where unsuitable conditions exist, based on the event data,
determine at least one alternate drop-off destination based on the area bounding the initial drop-off destination, and
receive a selection of one of the at least one alternate drop-off destinations for dropping-off one or more passengers.

14. The computer program product of claim 13, wherein the predetermined threshold is based on at least one of safety standards, regulations, and passenger preferences.

15. The computer program product of claim 13, wherein the event data is based on at least one of news data, social media data, v2X data, IoT data, and CCTV data.

16. The computer program product of claim 13, wherein data corresponding to one or more passenger profiles comprises at least one of a passenger's age, a passenger's medical condition, and a passenger's occupation.

17. The computer program product of claim 13, wherein the program instructions executable by a processor further cause the processor to determine the suitability score for the initial drop-off destination as the vehicle proceeds towards the initial drop-off destination.
